(19) United States
(12) Patent Application Publication
(10) Pub. No.: US 2019/0108775 A1
(43) Pub. Date: Apr. 11, 2019

(54) EXTENDED PRINT AREA LABEL AND SYSTEM AND METHOD OF USING THE SAME

(71) Applicant: Mehrdad Hariri, Maitland, FL (US)

(72) Inventor: Mehrdad Hariri, Maitland, FL (US)

(21) Appl. No.: 15/728,028

(22) Filed: Oct. 9, 2017

(51) Int. Cl. G09F 3/02; B32B 38/00; B32B 38/10; B41J 3/407; G09F 3/10; G09F 3/00

(52) U.S. Cl. CPC G09F 3/02; B32B 38/145; B32B 38/10; B41J 3/4075; G09F 3/10; G09F 2003/0222; B32B 2519/00; B32B 2439/00; G09F 2003/0226; G09F 2003/0273; G09F 2003/0201; G09F 3/0297

(57) ABSTRACT

An extended print area pharmaceutical label and system and method of using the same. A carrier sheet has a plurality of label areas having a front surface for printing indicia on the labels with a printer and a back surface having an adhesive layer securing the labels to a release layer secured by an adhesive to the carrier sheet. One label area is utilized to mark a pharmaceutical product container for dispensing of the pharmaceutical product. A second label area may be utilized for point of sale transactions or inventory and control processes. A third label area may be utilized as one or more of a coupon, reimbursement, or a rebate.

### BACKGROUND OF THE INVENTION

The present invention relates to label printing and, more particularly, to systems and methods for printing customized labels for application to prescription medication bottles.

While current labels and methods in the art provide for the inclusion of patient specific information pertaining to prescription contained within a medication bottle, the labels do not provide additional space to which a pharmacy may apply additional information for medicine containers or packages. Accordingly, space is not provided for offers, voucher, and other patient related information.

As can be seen, there is a need for an improved label and printing methods that provides an added area to the label to contain patent information and or offers, coupons and vouchers of interest to the patient.

### SUMMARY OF THE INVENTION

In one aspect of the present invention, a printable label sheet for marking pharmaceutical products to dispense to a patient, includes: a carrier sheet having a printable surface; and a release layer covering at least a portion of the carrier sheet and secured to the carrier sheet by a first adhesive layer. A plurality of label printing areas are carried on the release layer and have a front surface for receiving patient specific printed indicia thereon and a back surface having a second adhesive layer thereon, releasably securing the plurality of label printing areas to the release layer. The plurality of label printing areas may be carried in a spaced apart relation on the release layer. Alternatively, the plurality of label printing areas may be separable from one another along a score line.

The plurality of label printing areas include a first label portion configured for receiving patient specific indicia and indicia pertaining to the pharmaceutical product. The first label portion is dimensioned to be applied to an outer surface of a pharmaceutical container; and the second adhesive layer is a high tackiness adhesive. In other embodiments, the plurality of label printing areas includes a second label area configured to receive indicia providing additional information regarding the pharmaceutical product. The additional information may be a machine readable code for transacting a point of sale service. The additional information may also include inventory control information.

In yet other embodiments, the plurality of label printing areas includes a third label printing area configured to receive indicia pertaining to an offer for one or more of a discount or a reimbursement for the pharmaceutical product. The second adhesive layer for the third label printing area may be a low tackiness material that does not substantially adhere to other surfaces after removal from the release layer.

Other aspects of the invention include a method of using an extended area label for transactions involving dispensed pharmaceutical products: providing a blank extended area label sheet to a printer, the blank label sheet having a carrier sheet and a plurality of label areas releasably adhered to a release layer covering a portion of the carrier sheet. A first label portion is configured to dimensionally adhere to a circumferential portion of a pharmaceutical container. According to the method, patient specific indicia and pharmaceutical product indicia are printed on at least one of the plurality of label areas. Transaction information is printed on a second label area. Indicia for one or more of a discount or a reimbursement is printed on a third label area.

After printing, the first label portion may be removed from the release layer; and applied to the pharmaceutical container.

The second label area may be used to complete a point of sale transaction and in some aspects of the method the second label area is removed from the release layer to complete the point of sale transaction. In yet other aspects of the method, the third label area is presented as one of a coupon, a rebate, or a reimbursement. The third label area may also need to be removed from the release layer.

These and other features, aspects and advantages of the present invention will become better understood with reference to the following drawings, description and claims.

### BRIEF DESCRIPTION OF THE DRAWINGS

FIG. 1 is a perspective view of an extended label sheet;

FIG. 2 is a front elevation view of the extended label sheet, illustrating the partial removal of a plurality of adhesive label elements;

FIG. 3 is an exploded front elevation view of the extended label sheet;

FIG. 4 is an exploded rear elevation view of the adhesive label elements;

FIG. 5 is a front elevation view of a printed extended label sheet;

FIG. 6 is a front view of label elements adhered to a prescription bottle; and

FIG. 7 is a schematic view of a system architecture for utilizing the extended labels.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, embodiments of the present invention provide an improved system and method for providing patient specific information on a label sheet to accompany a prescription medication of a pharmaceutical product.

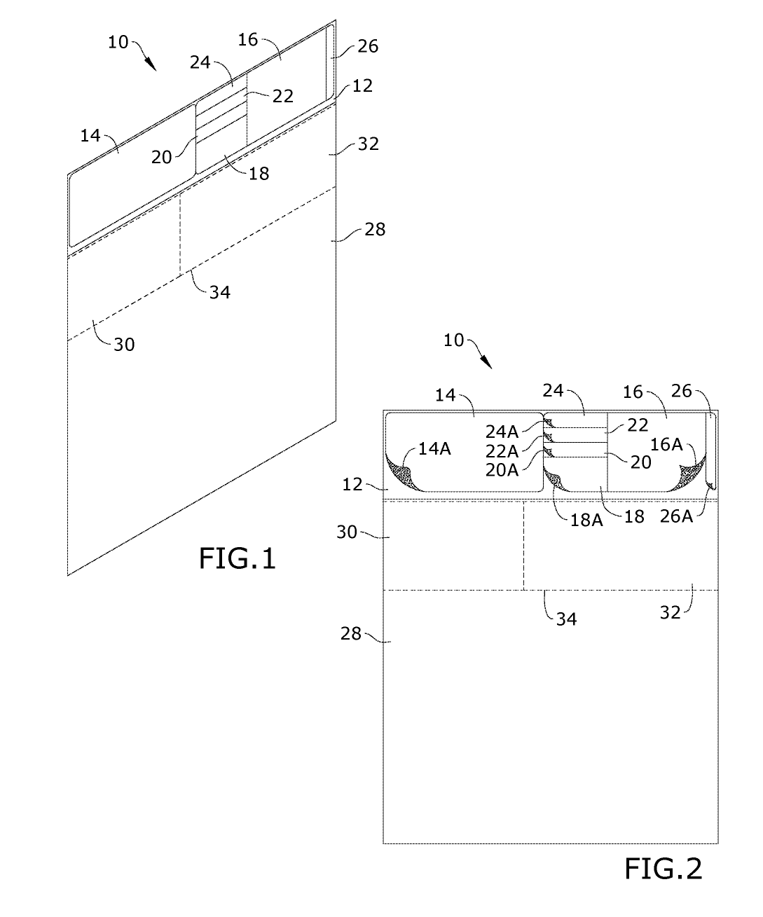

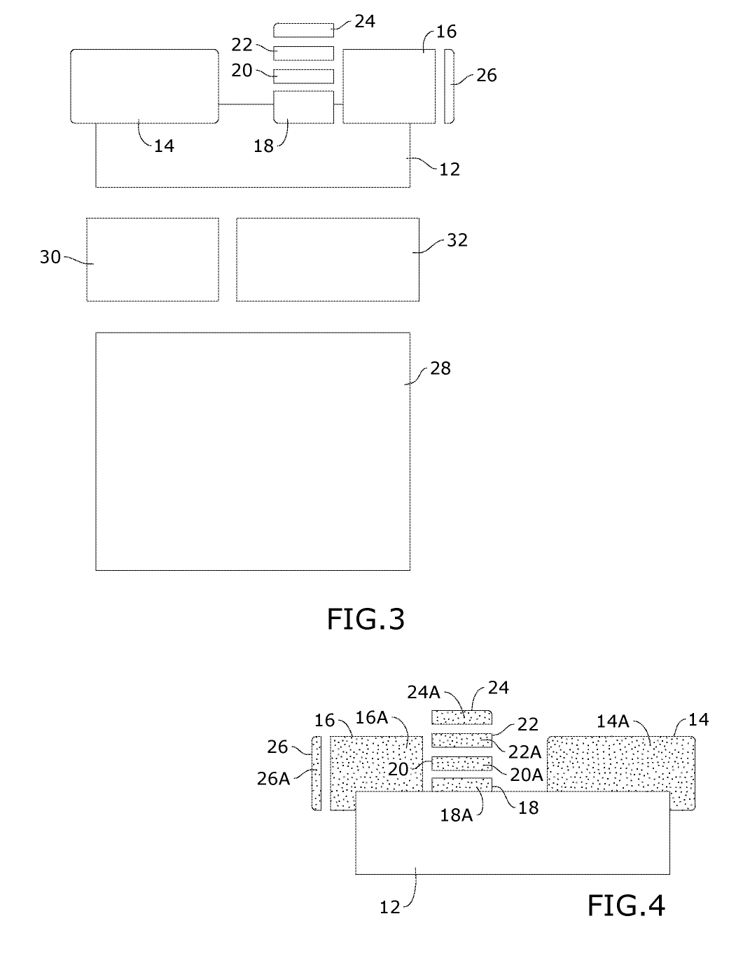

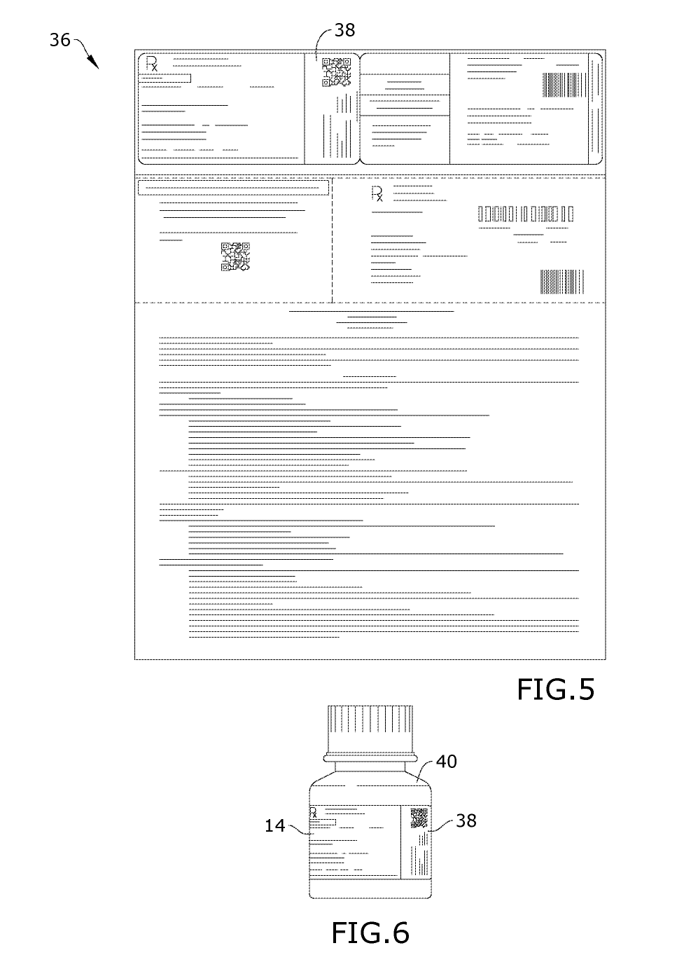

As seen in reference to FIG. 1-4, the label sheet 10, or blank includes a carrier sheet having a plurality of label printing areas 14, 16, 20, 22, 24 covering at least a portion of the a carrier sheet 10. The plurality of label printing areas 14, 16, 20, 22, 24 may be carried in a spaced apart relation on the label sheet 10 or may be separable from one another by a score line. By way of non-limiting example, the label printing areas 14, 16, 20, 22, 24 may include a first label area 14, a second label area 16, a third label area 20, a fourth label area 22, a fifth label area 24, and a sixth label area 26. The label printing areas 14, 16, 20, 22, 24, 26 have an outer surface to which the printer 42 may apply indicia relating to a patient prescription medicine. An inner surface of the plurality of label printing areas includes an adhesive layer 14a, 16a, 20a, 22a, 24a, 26a. The adhesive layers 14a, 16a, 20a, 22a, 24a releasably retain the respective label printing areas 14, 16, 20, 24 to a release layer 12 that is carried on a portion of the carrier sheet 10. A border area 26 may be a residual portion of the label sheet 36 that is not associated with any printed areas.

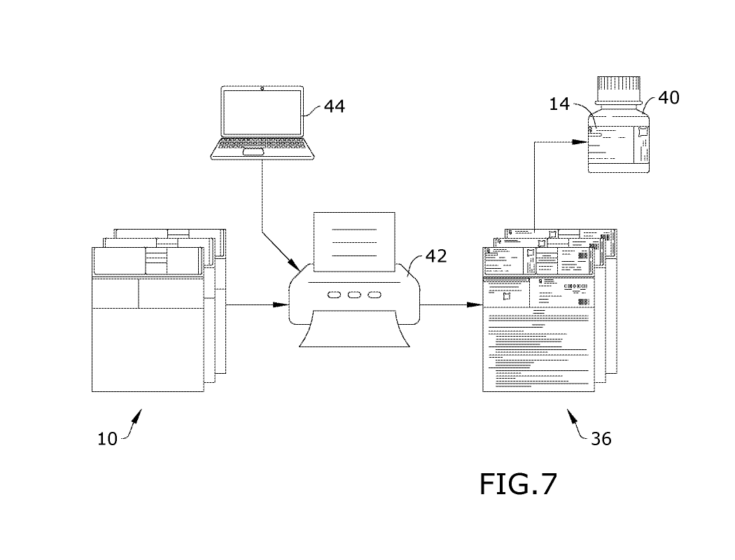

As seen in reference to FIGS. 7, a computing system 44 is utilized to enter or retrieve data for printing as indicia on the printed label sheet 36. The first label portion 14 may be detached from the carrier sheet 10, as shown in FIG. 2 and is applied to an outer surface of a container 40, such as a pharmaceutical bottle utilized by a pharmacy to dispense pharmaceutical products to a patient, as shown in reference to FIG. 7. The first label portion 14 is configured to dimensionally adhere to a circumference of a container 40. Preferably, the adhesive layer 14a has a high tackiness so as to keep the label adhered to the bottle 40 during normal use. The bottle label portion 14 carries indicia that is required by applicable laws and regulations for the pharmacy to dispense a pharmaceutical product to a patient. The bottle label portion 14 may also include a coded tab 38 for including a machine readable code, such as a barcode or a QR code, which may be utilized by the recipient of the medication to access reference information pertaining to the medication via a web site or other on-line resource that is encoded in the coded tab 38. Alternative the coded tab 38 also includes an extended area for printing offers, coupons, vouchers or other advertising related to the pharmacy which is attached to the label 14.

The second label printing area 16 may be utilized as a log sticker area. The log sticker 16 may be applied to the back of a hard copy of the dispensed prescription and filed with the records of the pharmacy to show that the patient received the prescription.

The third label printing area 18 may be utilized as a free form area 18. The free form area 18 may be used to print anything that the pharmacy would like. For example a QR Code, barcode, customer name and the like.

The fourth through sixth label printing areas 20, 22, 24 may be utilized for printing one or more special instructions that are adhered to the prescription container 40. The special instructions may pertain to the care or preparation of the medication, such as “Shake Well”, “Refrigerate”, and the like. Alternatively, the special instructions may pertain to patient conditions or warnings associated with taking the medication, “Take on a Full Stomach”, “Do Not Operate Machinery”, “May Cause Drowsiness”, and the like.

A plain paper area 28 may be carried below the first 30 and the second 32 printed card areas may be utilized for as a patient instruction area. The patient instruction area provides instructional information to the patient for the administration of the medication, which may include a description of one or more side effects of the medication, instructional information regarding adverse effects from taking the medication, and the like.

The first printed card area 30 may include patient identification information, including name, address, account number, prescription number. The second printed card area 32 may include a receipt area which may be retained by the patient for tax purposes or submitted by the patient for insurance reimbursement.

The extended label sheet 10 may also include a first 30 and a second 32 card printing area. A first card printing area 30 may, for example, be printed with indicia providing additional information or instructions to the patient regarding the dispensed medication or it may carry indicia for the quantity of medication dispensed, price, copays, or the like and may include a machine readable code, such as a barcode or a QR code, which may be utilized for purposes of patient payment and checkout for point of sale related services, as well as inventory control and pharmaceutical product tracking. The first card printing area 30 is detachable from the carrier sheet via perforations and may be applied to a supplemental container, such as a carton or a bag, for the patient to carry the pharmaceutical product.

In like manner, second card printing area 32 may receive indicia which may include the presentation of offers, vouchers, or other information for the patient to receive a discount or reimbursements pertaining to the dispensed pharmaceutical product, or other products carried by the pharmacy. By way of non-limiting example, the second card printing area 32 may be removed from the carrier 10 along perforations and applied as a letter, a postcard, or envelope for a mail-in type rebate or other reimbursement form.

As seen in reference to FIG. 7, an extended label printing system according to aspects the present invention includes a printer 42 a server, and at least one computing device 44 operatively connected to the printer 42 and the server. At least one extended label sheet 10, or label blank, is provided as an input source to the printer 42 upon which patient and medication specific information is applied by the printer 42 to output an extended printed label sheet 36. The printer 42 may be any type of printer, such as an ink, thermal, laser, or other type printer.

A method of using an extended area label according to aspects of the present invention may include the steps of providing a blank label sheet 10 to a printer 42. The blank label sheet 10 having a plurality of label areas 14, 16, 20, 22, 24, 26 each having an adhesive backing 14a, 16a, 20a, 22a, 24a, 26a covering at least a portion of the a carrier sheet 10, where the first label portion 14 is configured to dimensionally adhere to a circumference of a prescription container 40. The adhesive backing 24a, 26a, 28a is secured to the release layer 30. Printing patient-specific information on the blank label sheet 10. Removing the first label portion 24 from the release layer 30 and exposing the adhesive backing 24a on the first label portion 24. Applying the first label portion 24 to an outer surface of a container 40 to be utilized for holding the pharmaceutical product.

The method may also entail, removing a second of the plurality of label areas 16 and presenting the second label area 16 for completing a point of sale transaction. Data from the point of sale transaction may be utilized in one or more of an inventory or pharmaceutical tracking system.

The third label portion 20 may be removed from the carrier 22 and used in presenting the third label areas as one of a coupon, a rebate, or a reimbursement.

The system of the present invention may include at least one computer with a user interface. The computer may include any computer including, but not limited to, a desktop, laptop, and smart device, such as, a tablet and smart phone. The computer includes a program product including a machine-readable program code for causing, when executed, the computer to perform steps. The program product may include software which may either be loaded onto the computer or accessed by the computer. The loaded software may include an application on a smart device. The software may be accessed by the computer using a web browser. The computer may access the software via the web browser using the internet, extranet, intranet, host server, internet cloud and the like.

The computer-based data processing system and method described above is for purposes of example only, and may be implemented in any type of computer system or programming or processing environment, or in a computer program, alone or in conjunction with hardware. The present invention may also be implemented in software stored on a non-transitory computer-readable medium and executed as a computer program on a general purpose or special purpose computer. For clarity, only those aspects of the system germane to the invention are described, and product details well known in the art are omitted. For the same reason, the computer hardware is not described in further detail. It should thus be understood that the invention is not limited to any specific computer language, program, or computer. It is further contemplated that the present invention may be run on a stand-alone computer system, or may be run from a server computer system that can be accessed by a plurality of client computer systems interconnected over an intranet network, or that is accessible to clients over the Internet. In addition, many embodiments of the present invention have application to a wide range of industries. To the extent the present application discloses a system, the method implemented by that system, as well as software stored on a computer-readable medium and executed as a computer program to perform the method on a general purpose or special purpose computer, are within the scope of the present invention. Further, to the extent the present application discloses a method, a system of apparatuses configured to implement the method are within the scope of the present invention.

It should be understood, of course, that the foregoing relates to exemplary embodiments of the invention and that modifications may be made without departing from the spirit and scope of the invention as set forth in the following claims.

What is claimed is:

1. A printable label sheet for marking a container for a pharmaceutical product to dispense to a patient, comprising:
a carrier sheet having a printable surface;
a release layer covering at least a portion of the carrier sheet;
a plurality of label printing areas having a front surface for receiving patient specific printed indicia thereon and a back surface having an adhesive layer thereon, the adhesive layer releasably securing the plurality of label printing areas to the release layer.

2. The printable label sheet of claim 1, wherein the plurality of label printing areas are carried in a spaced apart relation.

3. The printable label sheet of claim 1, wherein the plurality of label printing areas are separable from one another along a score line.

4. The printable label sheet of claim 1, wherein the plurality of label printing areas further comprises:
a first label portion configured for receiving patient specific indicia and indicia pertaining to the pharmaceutical product, the first label portion dimensioned to be applied to an outer surface of the container; and the second adhesive layer is a high tackiness adhesive.

5. The printable label sheet of claim 4, wherein the plurality of label printing areas further comprises:
a second label printing area configured to receive indicia providing additional information regarding the pharmaceutical product.

6. The printable label sheet of claim 5, wherein the additional information comprises:
a machine readable code for transacting a point of sale service.

7. The printable label sheet of claim 6, wherein the additional information comprises inventory control information.

8. The printable label sheet of claim 7, wherein the plurality of label printing areas further comprises:
a third label printing area configured to receive indicia pertaining to an offer for one or more of a discount or a reimbursement for the pharmaceutical product.

9. A method of using an extended area label for transactions involving dispensed pharmaceutical products:
providing a blank label sheet to a printer, the blank label sheet having a carrier sheet and a plurality of label areas releasably adhered to a release layer covering a portion of the carrier sheet, where a first label portion is configured to dimensionally adhere to a circumferential portion of a pharmaceutical container;
printing patient specific indicia and pharmaceutical product indicia on at least one of the plurality of label areas;
printing transaction information on a second label area; and
printing one or more of a discount or a reimbursement on a third label area.

10. The method of claim 9, further comprising:
removing the first label portion from the release layer; and
applying the first label portion to the pharmaceutical container.

11. The method of claim 10, further comprising:
presenting the second label area to complete a point of sale transaction.

12. The method of claim 11, further comprising:
removing the second label area from the release layer.

13. The method of claim 12, further comprising:
presenting the third label area as one of a coupon, a rebate, or a reimbursement.

14. The method of claim 13, further comprising:
removing the third label area from the release layer.
